(19) United States
(12) Patent Application Publication
(10) Pub. No.: US 2018/0316834 A1
(43) Pub. Date: Nov. 1, 2018

(54) VIDEO SYSTEM AND METHOD FOR ALLOWING USERS, INCLUDING MEDICAL PROFESSIONALS, TO CAPTURE VIDEO OF SURGICAL PROCEDURES

(71) Applicant: Ryan GRABOW, Henderson, NV (US)

(72) Inventor: Ryan GRABOW, Henderson, NV (US)

(21) Appl. No.: 15/965,433

(22) Filed: Apr. 27, 2018

Related U.S. Application Data
(60) Provisional application No. 62/491,986, filed on Apr. 28, 2017.

(51) Int. Cl. H04N 5/225; H04N 7/18; H04N 5/232; H04N 5/77

(52) U.S. Cl. CPC H04N 5/2253; H04N 5/2258; H04N 5/77; H04N 5/23293; H04N 7/185

(57) ABSTRACT

A system for mounting a video camera to surgical head wear. The system may include a camera mount formed of a camera retention member, linkage and means for attachment to surgical head wear. A video storage unit may be mounted to the head wear proximate to the video camera and connected thereto. The system described herein permits surgeons to capture video of surgical procedures. The video may be stored for later dissemination and/or observed remotely in real-time. A video boom system may be used as well.

### CROSS-REFERENCE

This application claims priority to U.S. Patent Application No. 62/491,986 filed Apr. 28, 2017 and incorporated herein for any and all purposes.

### FIELD OF THE INVENTION

The embodiments of the present invention relate to a head-mounted video system allowing surgeons, or other users, to capture, share, and/or transmit live video of medical or surgical procedures or other activities from a surgeon's or other wearer's point-of-view.

### BACKGROUND

Video systems that capture and/or share live view video have multiple benefits, such as: (i) capture a “How-to” video; (ii) provide “live view” of a procedure or activity to enable those present to “see” from the instructor's perspective; (iii) document that the required steps in a procedure were completed; (iv) allow viewers of “live” video to comment on the technique. This type of video system benefits individuals with multiple activities or trades, arts and crafts projects, fly tying, wood workers, plumbers, cabinet makers and the like. Healthcare workers, such as nurses, physical therapists, physicians and surgeons are ideally situated to benefit from this type of video system.

Videos depicting medical and surgical procedures have many uses including patient, staff and/or student education. For example, a video showing a surgical procedure can educate a medical student or resident in the “how-to” of a procedure and also help educate a patient regarding the upcoming procedure. The use of video to educate physicians-in-training is a powerful tool to allow repeated viewing of the procedure from the surgeon's perspective, both in the operating room or away from the operating room or clinic. However, capturing video of medical and surgical procedures from the physician's point-of-view, especially surgeries, is challenging. Cameras mounted in lights or aimed over a surgeon's shoulder cannot be positioned to capture the exact surgeon's viewing angle or are blocked by the surgeon's head during critical portions of the procedure. The operative wound may be deep and prevent a camera from focusing on the desired anatomy. Professional camera crews may help but are typically cost prohibitive. Current head-worn cameras for healthcare are tethered to a computer limiting a surgeon's mobility. Additionally, they provide less than optimal video and are outdated by today's video standards.

Current sports or “action” cameras presently offer many possibilities to capture point-of-view video, but are unfortunately limited in many ways. There is presently no way to securely mount an action camera to the wearer's head to place the lens at eye level to capture true point-of-view video. They are limited in battery power, recording length, ability to magnify and are unable to provide a true live image for observers to view. Additionally, batteries and memory cards cannot be changed easily without stopping the task or surgical procedure being recorded.

It would be advantageous to develop a head-mounted video system configured to capture video from the wearer's point-of-view that not only enables the recording of an activity or surgical procedure, but also provides a “live view” of the camera output, wirelessly to an external monitor or recorder to allow spectators to “observe” what the wearer is “observing” for healthcare, surgery and other activities. Additionally, it would be advantageous for the system to provide an extended length of operation allowing the wearer to record and/or transmit video continuously over the course of a normal work day (>8.5 hours) enabling the wearer to use the system for a full day, without stopping to change batteries or memory cards. Additionally, it would be advantageous to provide a means for the wearer to “observe” and monitor the live output of the camera to ensure that the lens is pointed at the desired subject. Additionally, it would be advantageous to provide a video system adaptable to allow the user to attach the system to other types of head-worn equipment.

### SUMMARY

Accordingly, a video system based on the embodiments of the present invention may utilize standard and modified sports/action cameras; head-worn apparatuses; mounts for attaching action cameras to said head-worn apparatuses, said mounts permitting said action camera to rotate at least upward and downward; means to prevent audio recording of said action camera as desired; means to provide remote battery power to said action camera; a remote battery for powering said action camera for extended use; means for preventing audio recording from action cameras; video out wire to connect said action camera live video output to wireless video transmitter; a wireless video transmitter and receiver to transmit and receive live video output of said action camera; a remote video recorder connected to said wireless video receiver; a portable monitor; a wearable high definition (HD) monitor to show live camera output to wearer; signal splitter to send live camera output to wearable HD monitor and wireless video transmitter; and waist pack to hold remote battery, splitter, and video transmitter around wearer's waist.

Depending on the embodiment, the head-worn apparatus may be head wear, a headband or headwear for surgical headlights or loupes, surgical head wear, total joint arthroplasty helmet and/or hood isolation hood or hard hat. Additional, mounting arms may also be attached to said head-worn mount for multiple configurations. Custom head wear mounting options will become evident from the following detailed descriptions, drawings, and claims.

Other variations, embodiments and features of the present invention will become evident from the following detailed description, drawings and claims.

### BRIEF DESCRIPTION OF THE DRAWINGS

FIG. 1A illustrates a front view of a camera attached to head wear; FIG. 1B illustrates a side view of the camera attached to head wear; FIG. 1C illustrates a bottom views of the camera attached to head wear; and FIG. 1D illustrates a close-up bottom view of the camera attached to head wear according to the embodiments of the present invention;

FIG. 1E illustrates the camera and mount from FIGS. 1A through 1D according to the embodiments of the present invention;

FIG. 2A illustrates a front view of a camera attached to head wear; FIG. 2B illustrates a first side view of the camera attached to head wear; and FIG. 2C illustrates a second side view of the camera attached to head wear according to the embodiments of the present invention;

FIG. 2D illustrates the camera and mount from FIGS. 2A through 2C according to the embodiments of the present invention;

FIG. 3A illustrates a front view of a light and camera mount attached to head wear; FIG. 3B illustrates a first side view of the light and camera mount attached to head wear; FIG. 3C illustrates a second side view of the light and camera mount attached to head wear; and FIG. 3D illustrates a top down view of the light and camera mount attached to head wear according to the embodiments of the present invention;

FIG. 3E illustrates a bottom view of the camera mount from FIGS. 3A through 3D with a camera installed therein; FIG. 3F illustrates a front view of the camera mount from FIGS. 3A through 3D with a camera installed therein; and FIG. 3G illustrates a side view of the camera mount from FIGS. 3A through 3D with a camera installed therein according to the embodiments of the present invention;

FIG. 4A illustrates a front view of a light and camera mount attached to head wear; and FIG. 4B illustrates a side view of the light and camera mount attached to head wear according to the embodiments of the present invention;

FIG. 5A illustrates a first top down view of the camera mount attached to head wear; and FIG. 5B illustrates a second top down view of the camera mount attached to head wear according to the embodiments of the present invention;

FIG. 6A illustrates a front view of a camera attached to head wear; and FIG. 6B illustrates a side view of the camera attached to head wear according to the embodiments of the present invention;

FIG. 7A illustrates a front view of a light and camera mounted to head wear; and FIG. 7B illustrates a side view of the light and camera mounted to head wear according to the embodiments of the present invention;

FIG. 8A illustrates various mounts used to attach lights and/or cameras to head wear; and FIG. 8B illustrates a mount according to the embodiments of the present invention;

FIG. 9A illustrates a first front view of a double camera mount attached to head wear;

FIG. 9B illustrates a second front view of a double camera mount attached to head wear; FIG. 9C illustrates a third front view of a double camera mount attached to head wear; and FIG. 9D illustrates a rear view of a double camera mount attached to head wear according to the embodiments of the present invention;

FIG. 10A illustrates a side view of a camera and video storage unit mounted to head wear; FIG. 10B illustrates a video storage unit mount from FIG. 10A; FIG. 10C illustrates a side view of a camera and video storage unit mounted to head wear; FIG. 10D illustrates a video storage unit mount from FIG. 10C according to the embodiments of the present invention;

FIG. 11A illustrates a custom camera mount and video storage unit mount on Integra-branded head wear; and FIG. 11B illustrates the video storage unit mount from FIG. 11A according to the embodiments of the present invention;

FIG. 12A illustrates a side view of a custom mount on MedLED-branded head wear; FIG. 12B illustrates an exemplary mount collar; and FIG. 12C illustrates a top down view of the custom mount on MedLED-branded head wear mount according to the embodiments of the present invention;

FIG. 12D illustrates the custom mount from FIGS. 12A through 12C according to the embodiments of the present invention;

FIG. 13A illustrates a side view of a custom mount on Ronin-branded head wear according to the embodiments of the present invention;

FIG. 13B illustrates a first side view of the custom mount from FIG. 13A; and FIG. 13C illustrates a first side view of the custom mount from FIG. 13A according to the embodiments of the present invention; and

FIG. 14 illustrates a surgery camera video boom system according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

The components detailed herein may be fabricated using any number of materials including plastics, alloys, metals, polymers, composites and combinations thereof and fabricated using any number of techniques including machining, injection molding, additive printing, casting and combinations thereof.

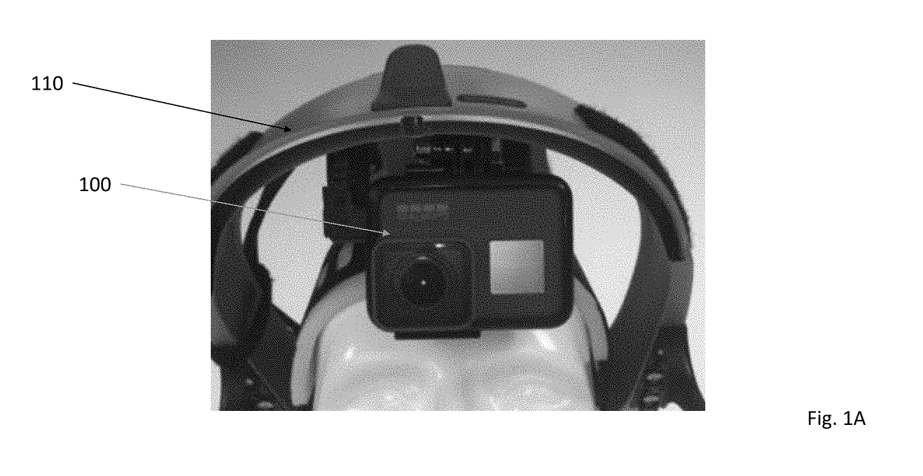

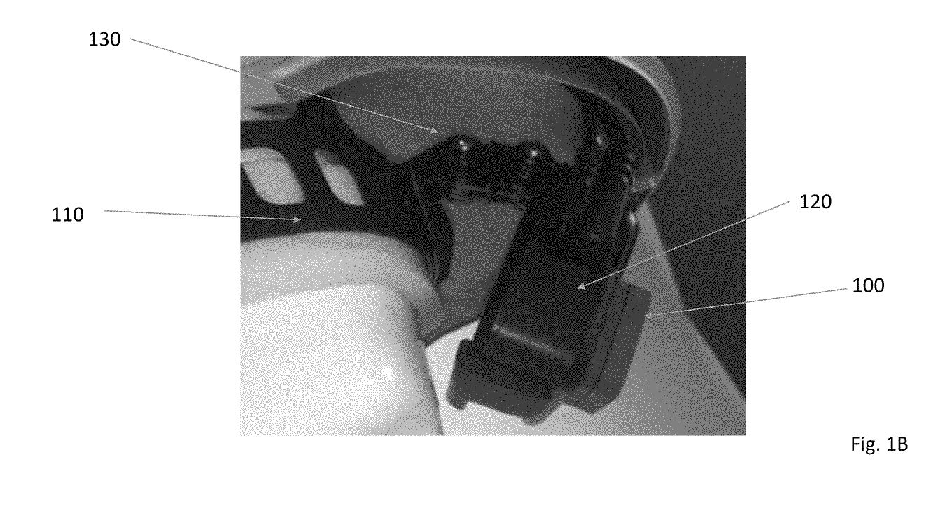

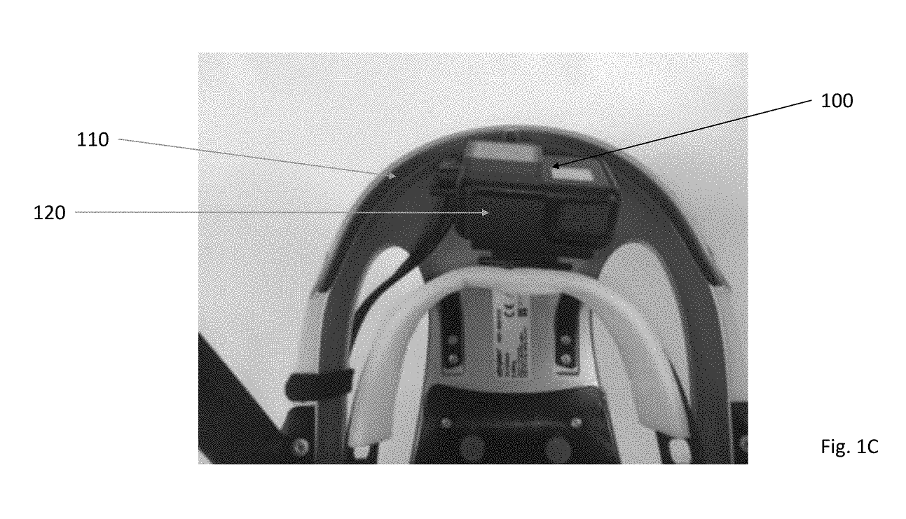

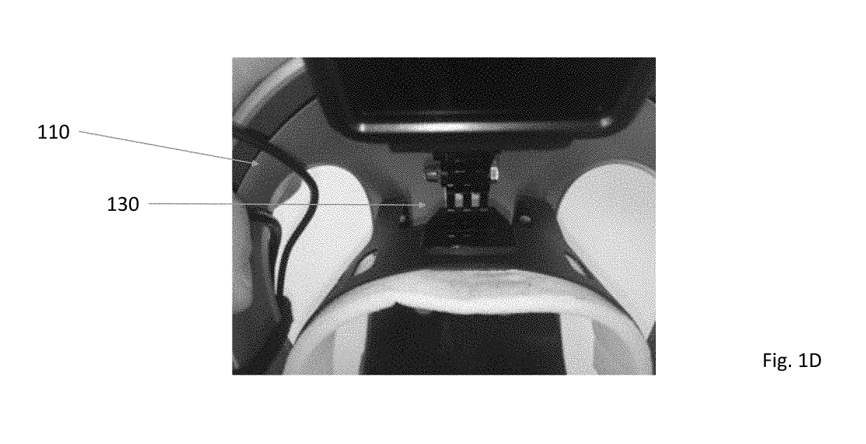

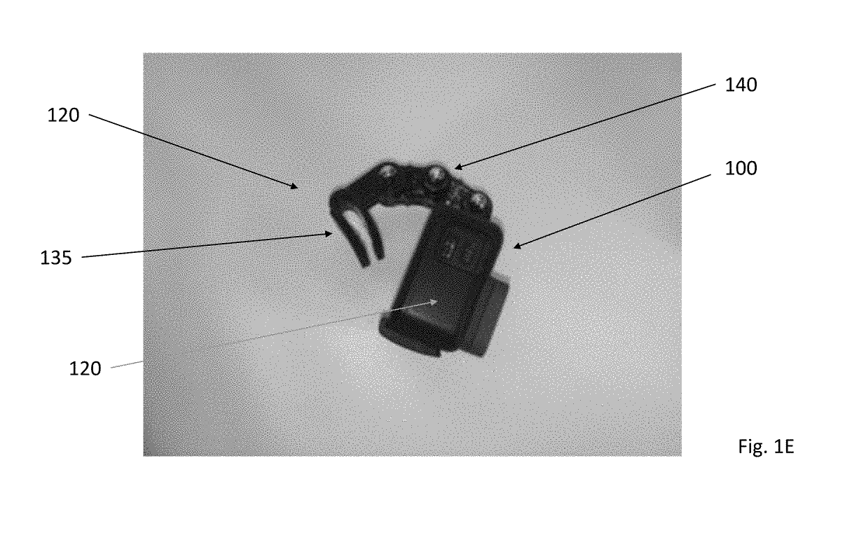

FIGS. 1A through 1D show a camera 100 attached to head wear 110 according to the embodiments of the present invention. As best seen in FIG. 1E, a mount 120 comprises a camera retention member 125, clip 135 and linkage 140. The linkage 140 comprises 3 segments but those skilled in the art will recognize that linkages described herein may comprise any number of segments connected to one another to traverse from a connection point with subject head wear to a subject video camera. The linkage segments rotatably join to one another using interleafed members having a rod inserted therethrough which said segments may rotate. The clip 135 permits the mount 130 to be attached to the head wear 110 while linkage 140 allows the camera 100 to be directionally manipulated relative to the head wear 110. The camera retention member 125, in the form of a frame, includes cut-outs for allowing camera ports and/or inputs and/or outputs to be accessed.

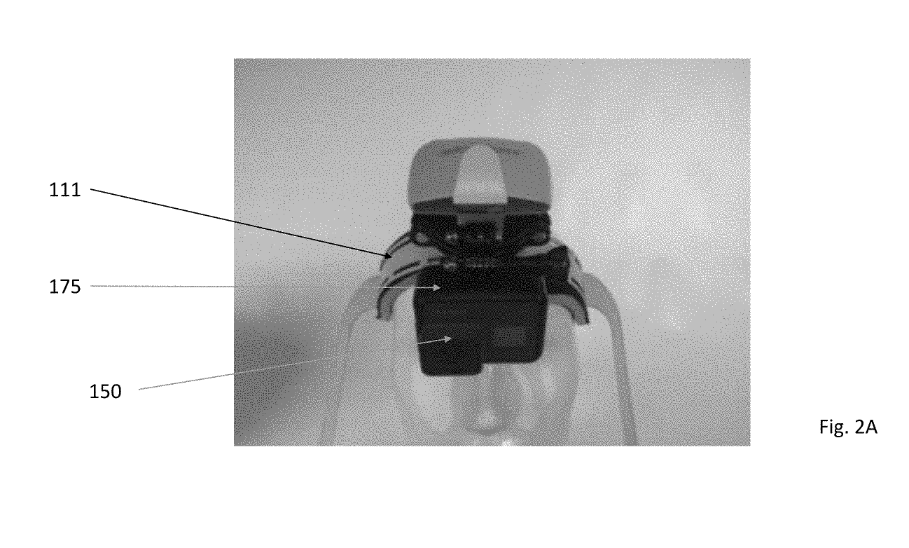

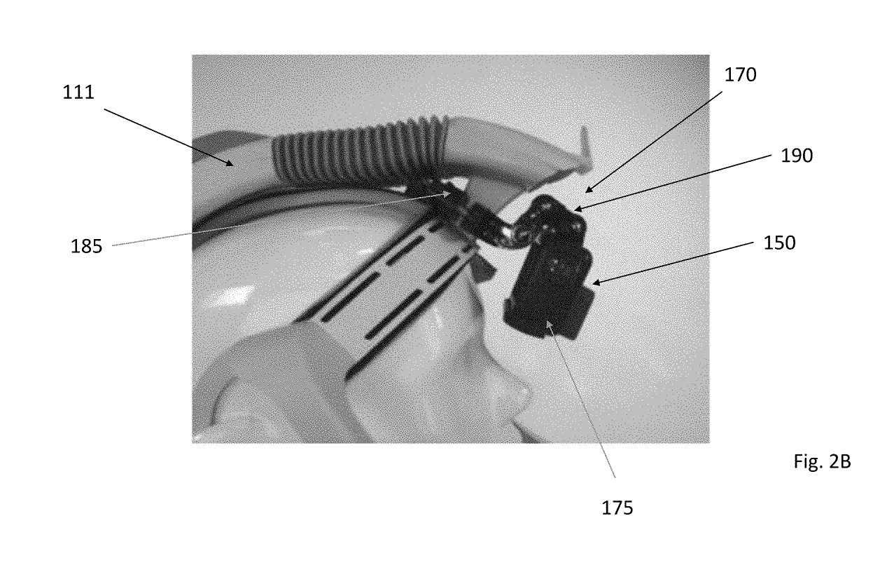

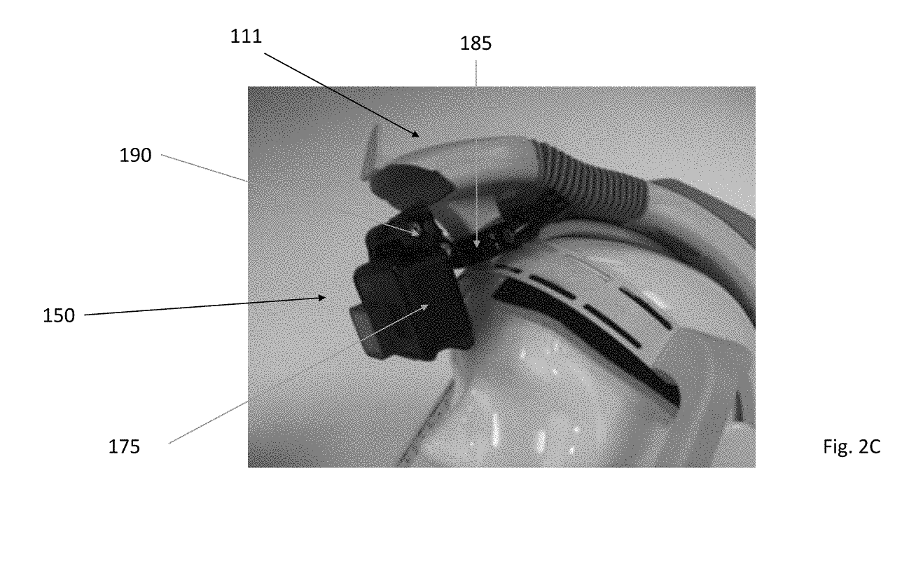

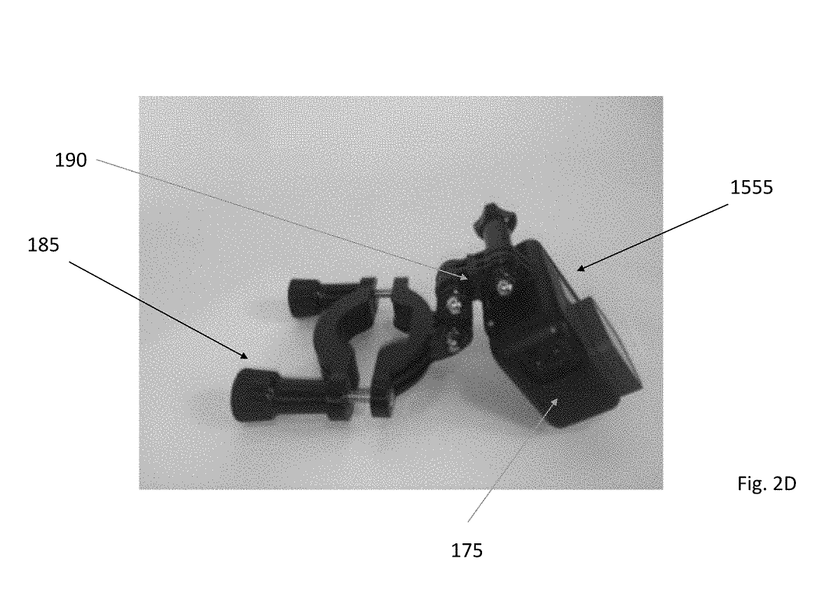

FIGS. 2A through 2C show a camera 150 attached to head wear 111 according to the embodiments of the present invention. As best seen in FIG. 2D, a mount 170 comprises a camera retention member 175, an adjustable, two-piece clamp 185 and linkage 190. The adjustable, two-piece clamp 185 permits the mount 180 to be attached to the head wear 111 while linkage 190 allows the camera 150 to be directionally manipulated relative to the head wear 111. The camera retention member 175 includes cut-outs for allowing camera ports and/or inputs and/or outputs to be accessed.

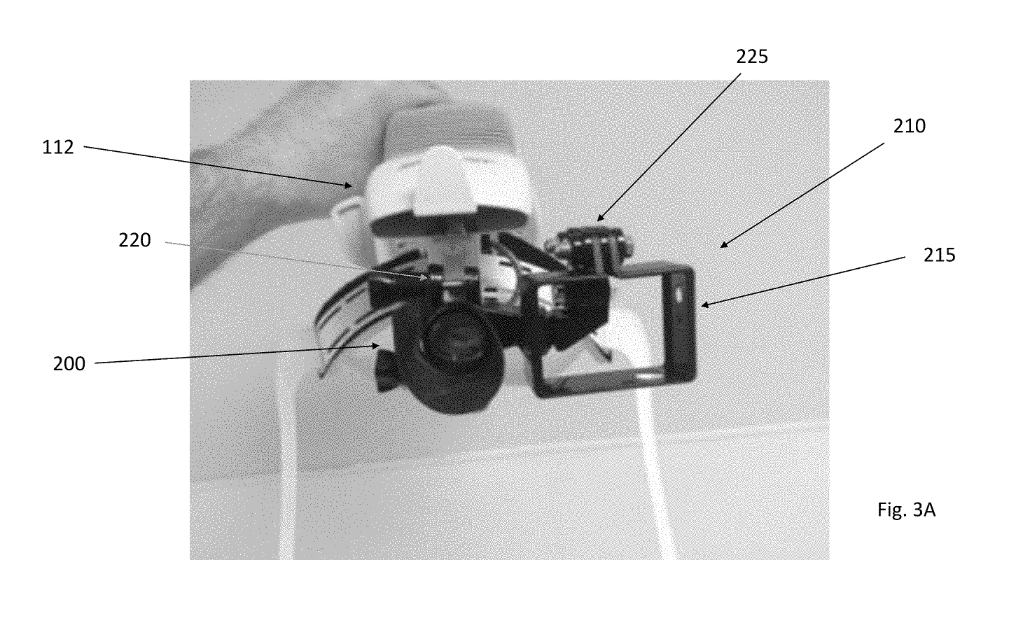

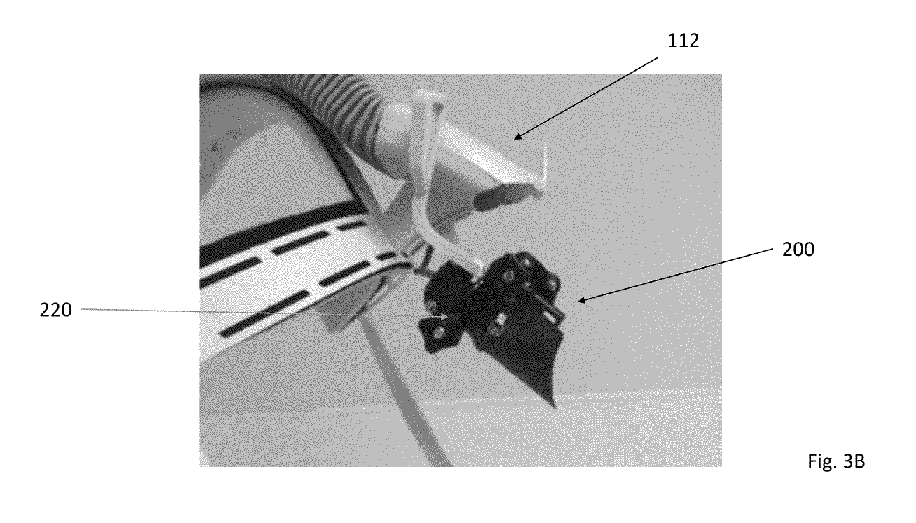

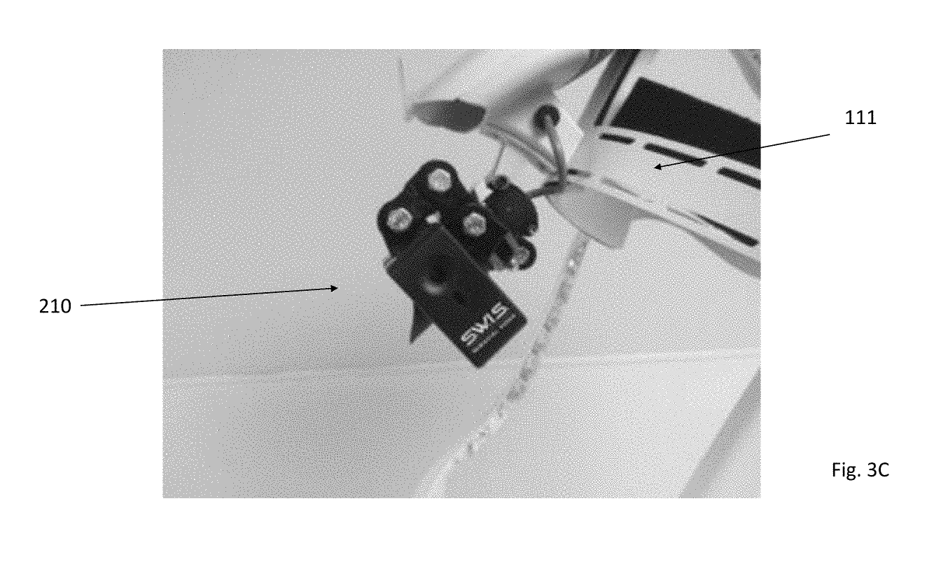

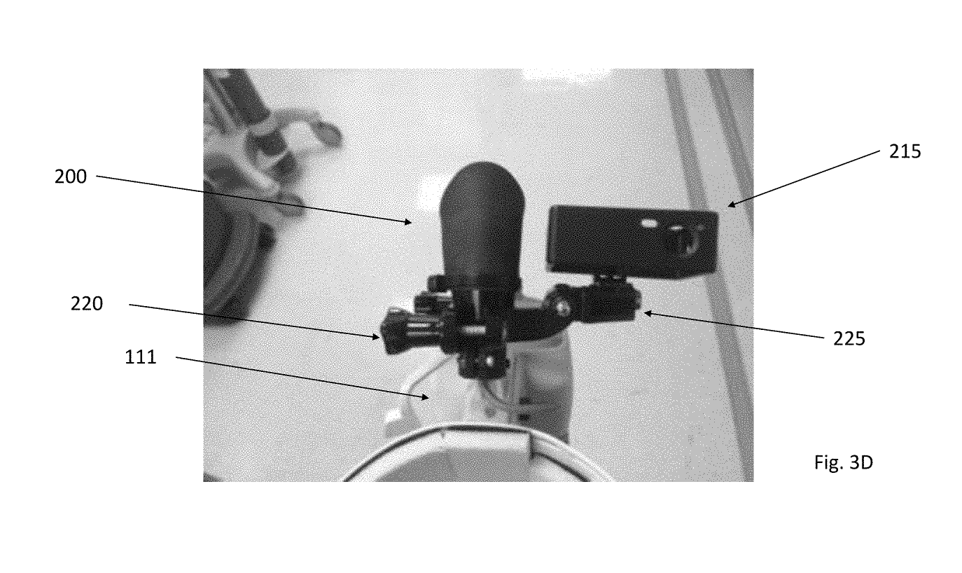

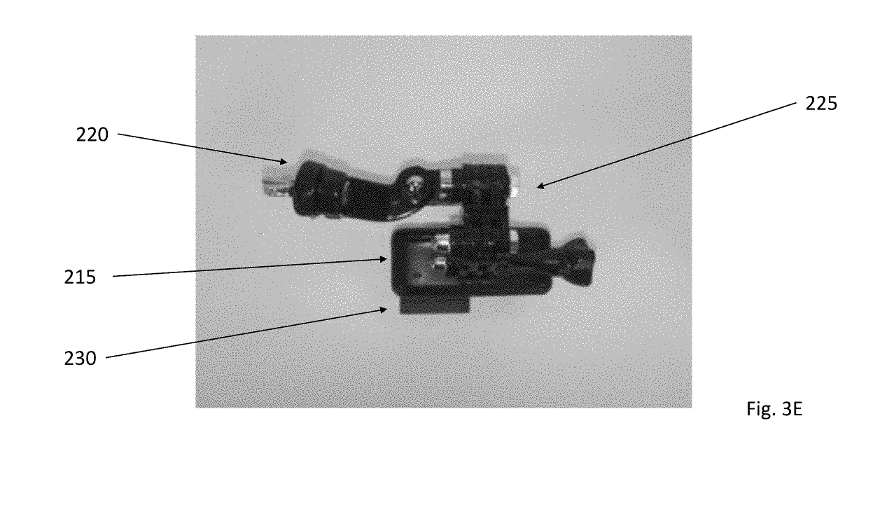

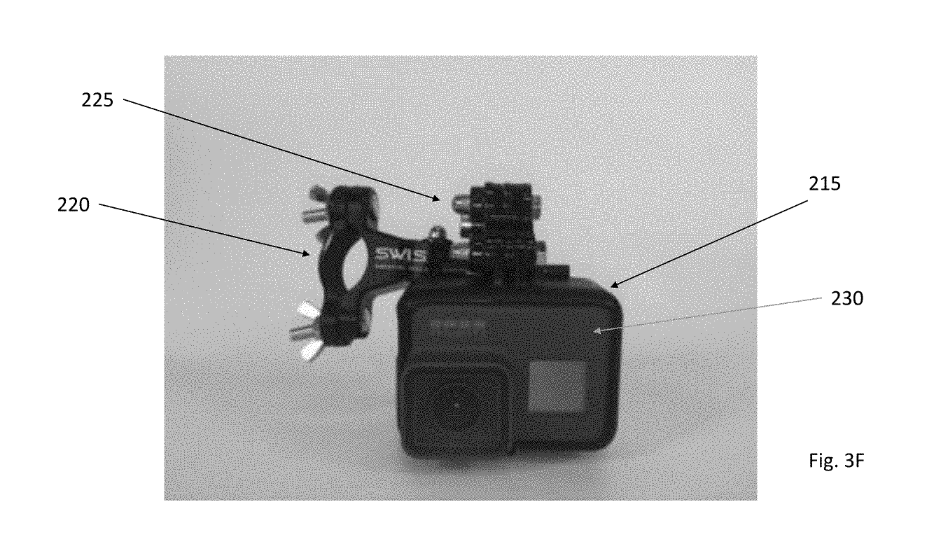

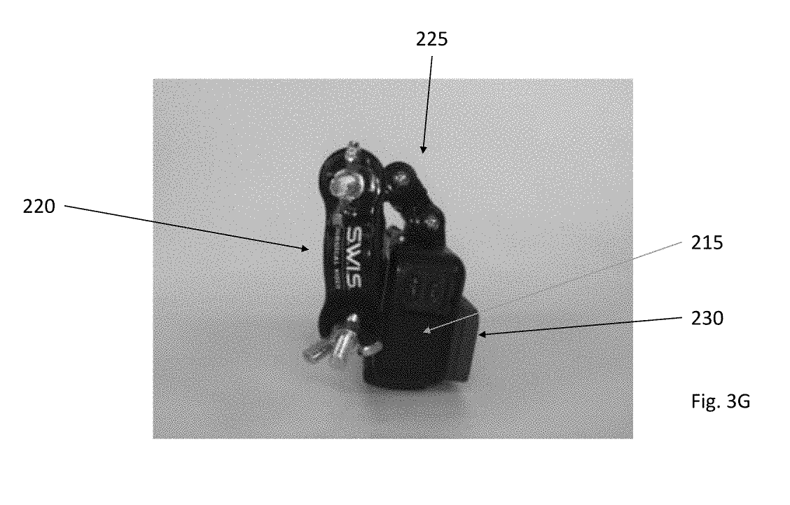

FIGS. 3A through 3D show a light 200 and camera mount 210 attached to head wear 112 according to the embodiments of the present invention. As best seen in FIGS. 3E through 3G, camera mount 210 comprises a camera retention member 215, adjustable, two-piece clamp 220 and linkage 225. The adjustable, two-piece clamp 220 permits the mount 210 to be attached to the head wear 112, via the light 200, while linkage 225 allows a camera 230 to be directionally manipulated relative to the head wear 112. The light 200 may be fixed to the head wear 112 or attached using a mount similar to the camera mount 210. The camera retention member 215 includes cut-outs allowing camera ports and/or inputs and/or outputs to be accessed.

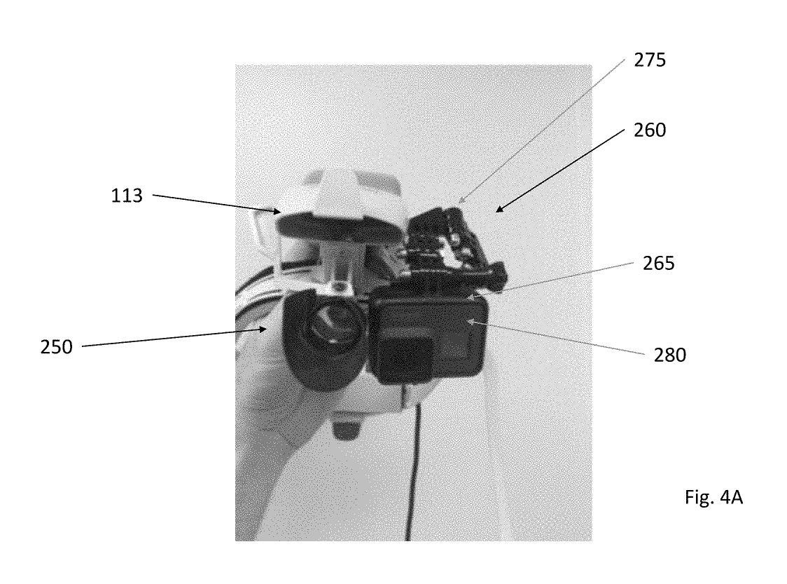

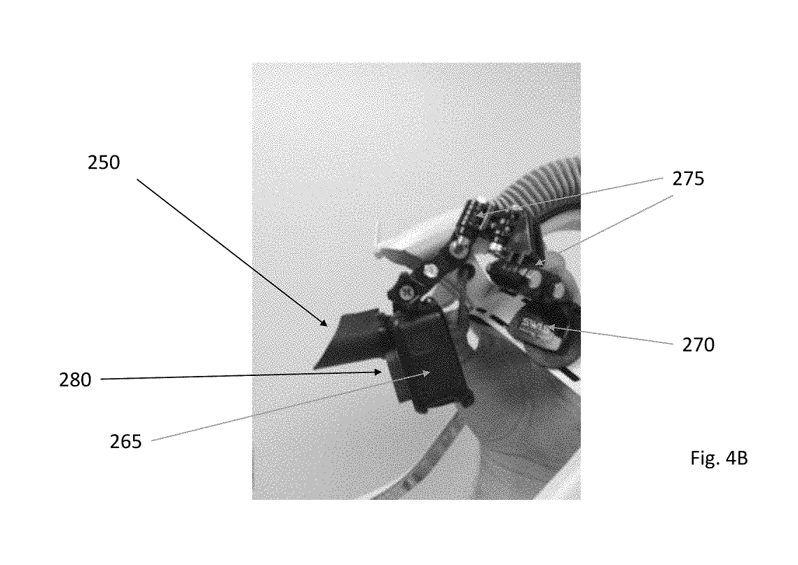

FIGS. 4A and 4B show a light 250 and second camera mount 260 attached to head wear 113 according to the embodiments of the present invention. In this embodiment, the camera mount 260 comprises a camera retention member 265, clip 270 and multi-directional linkage 275. The multi-directional linkage 275 is configured to permit camera 280 to be positioned adjacent to light 250 while the clip 270 is attached to the head wear 113. The camera retention member 265 includes cut-outs allowing camera ports and/or inputs and/or outputs to be accessed.

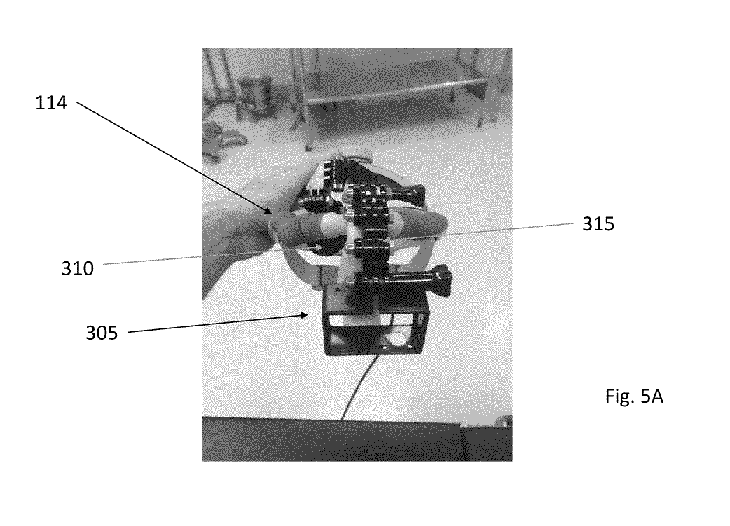

FIGS. 5A and 5B show a camera mount 300 attached to head wear 114 according to the embodiments of the present invention. In this embodiment, the camera mount 300 comprises a camera retention member 305, clip 310 and multi-directional linkage 315. The multi-directional linkage 315 is configured to traverse over a top portion of the head wear 114 from the point where the clip 310 attaches to the head wear 114. The camera retention member 305 includes cut-outs allowing camera ports and/or inputs and/or outputs to be accessed.

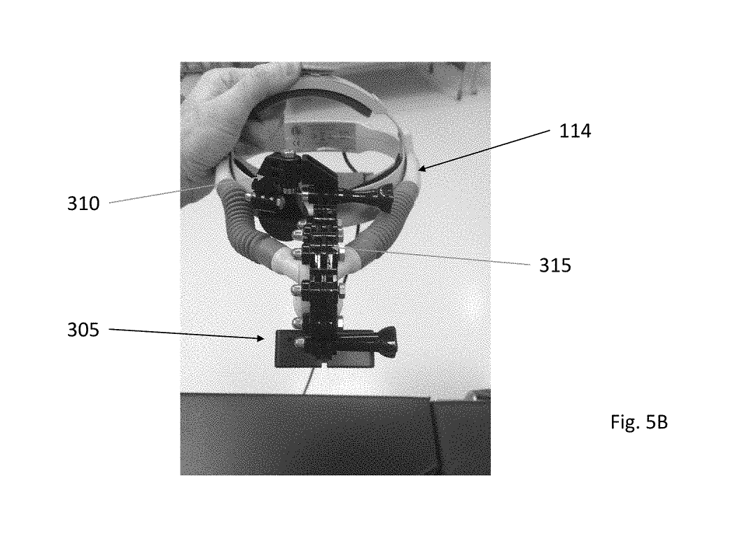

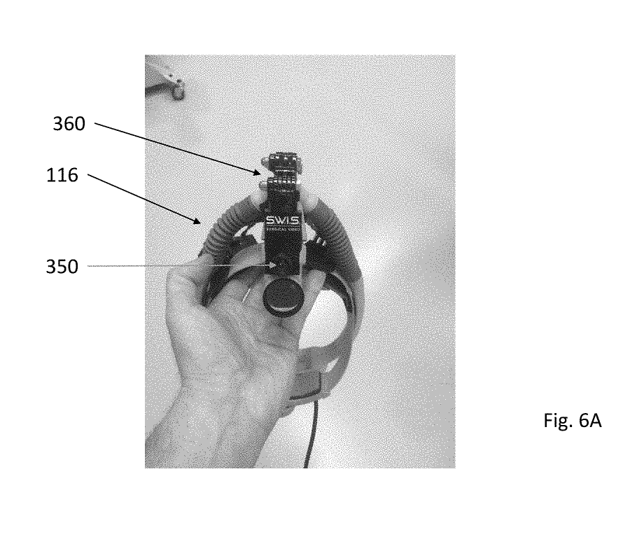

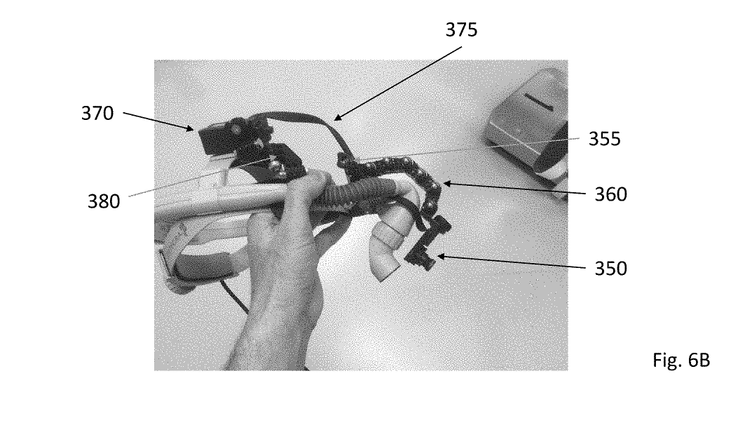

FIGS. 6A and 6B show a second camera 350 attached to head wear 116 according to the embodiments of the present invention. The second camera 350 is attached to the head wear 114 via an adjustable clamp 355 and linkage 360. A video storage device 370 connects to the camera 350 via a data cable 375. The video storage device 370 attaches to the head wear 116 via a clip or clamp and linkage 380.

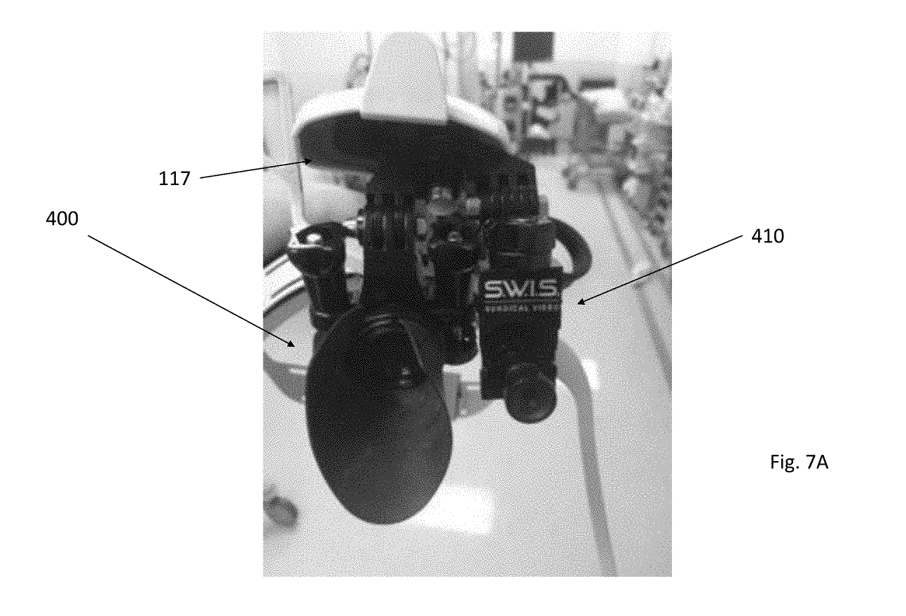

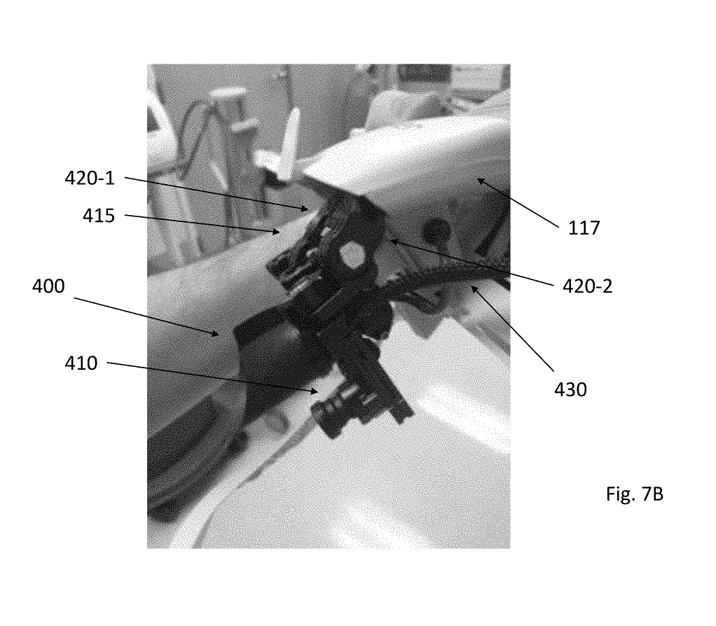

FIGS. 7A and 7B show a light 400 and camera 410 mounted to head wear 117 according to the embodiments of the present invention. A U-shaped mount 415 includes a pair of linkages 420-1, 420-2 for attachment to the light 400 and camera 410. Cable 430 connects camera 410 to a video storage device (not shown).

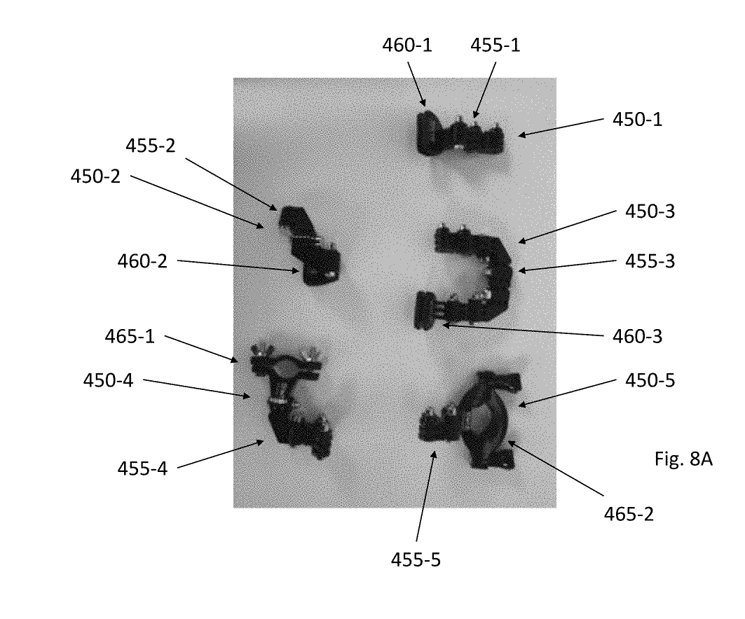

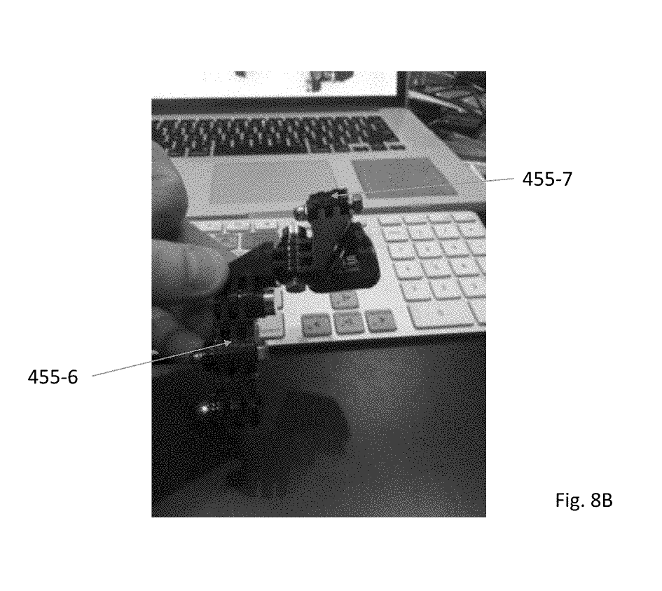

FIGS. 8A and 8B show various mounts 450-1 through 450-6 of the types used to attach lights and/or cameras to head wear as illustrated in FIGS. 1A through 7B according to the embodiments of the present invention. Mounts 450-1 through 450-3 include linkage 455-1 through 455-3 and clips 460-1 through 460-3; mounts 450-4 and 450-5 include linkage 455-4, 455-5 and adjustable clamps 470-1, 470-2 and mount 450-6 includes multiple linkages 455-6 and 455-7.

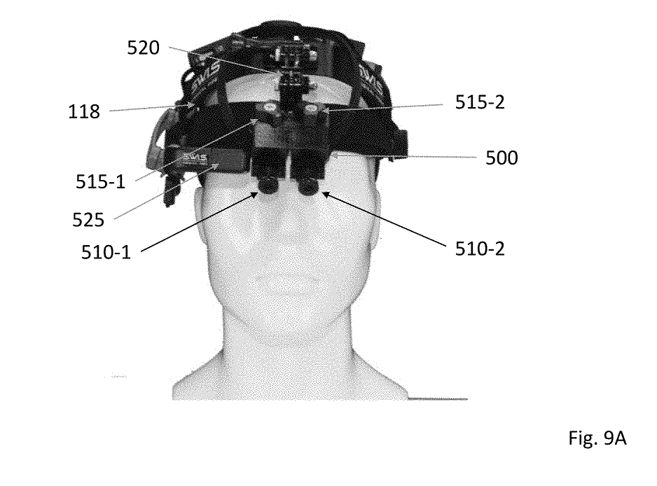

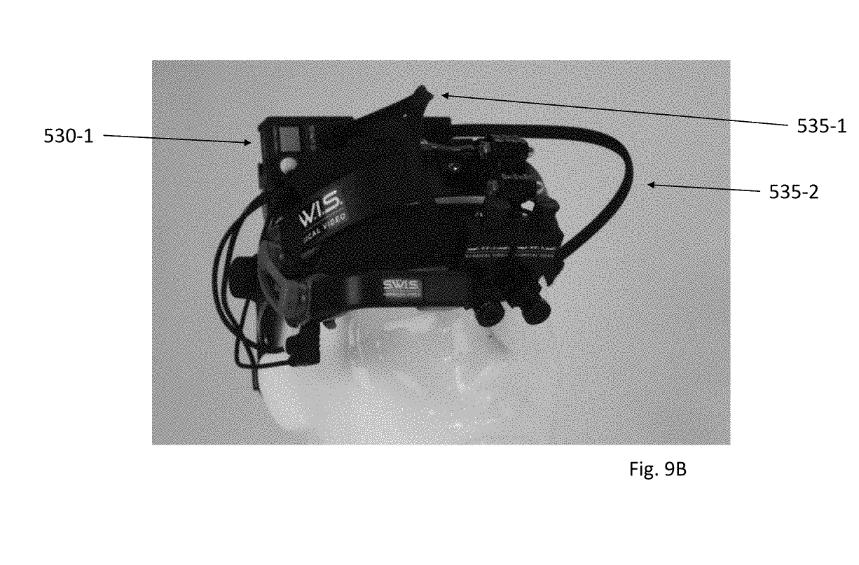

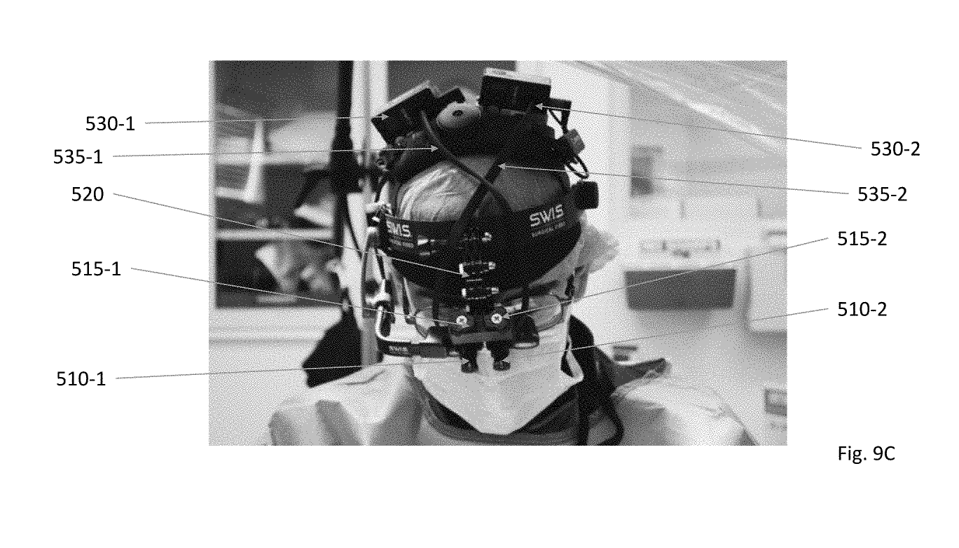

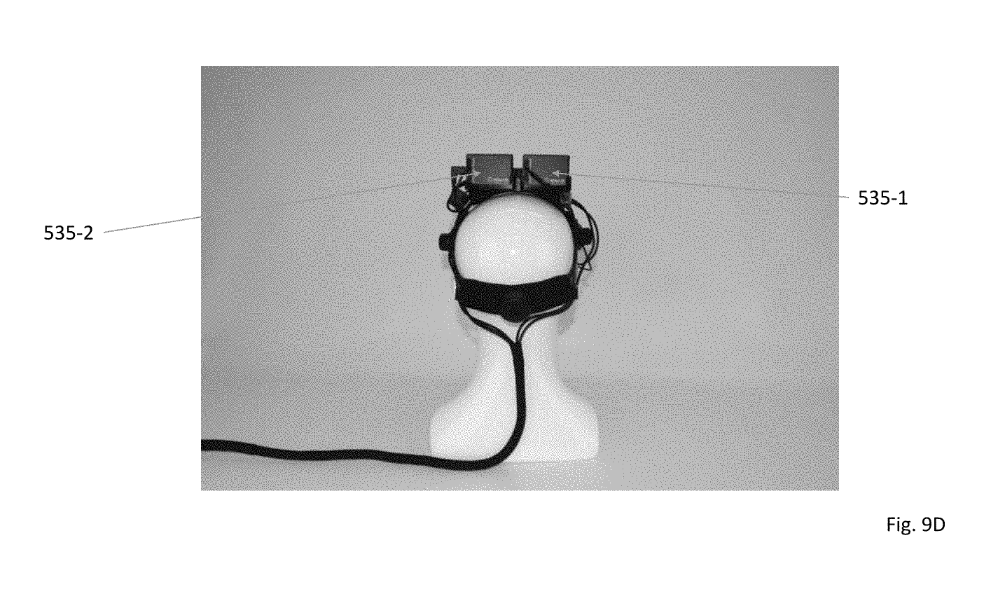

FIGS. 9A through 9D show a double camera mount 500 attached to head wear 118 according to the embodiments of the present invention. The double camera mount 500 is configured to retain two cameras 510-1, 510-2 via a pair of adjustable fasteners 515-1, 515-2. Linkage 520 facilitates attachment to the head wear 118. A display 525 allows a user to visualize the content being captured by the cameras 510-1, 510-2. A pair of video storage units 530-1, 530-2 attach to the cameras 510-1, 510-2 via cables 535-1, 535-2, respectively.

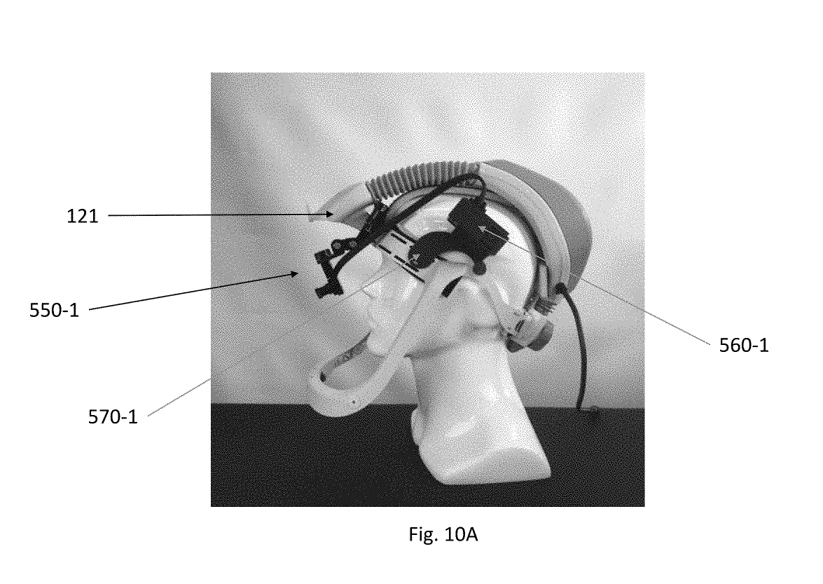

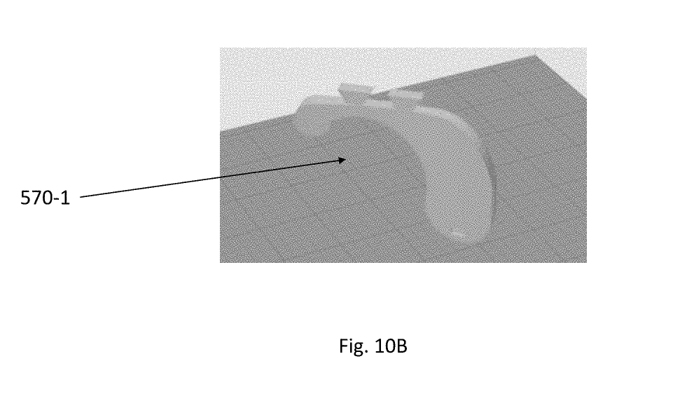

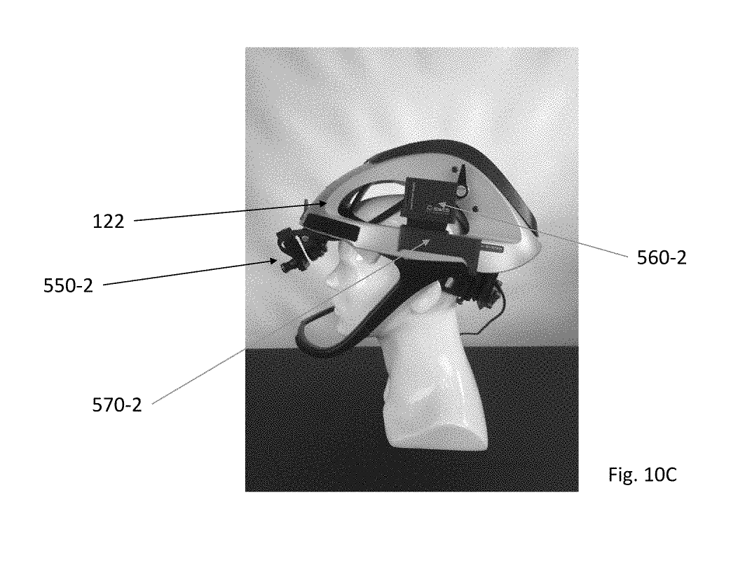

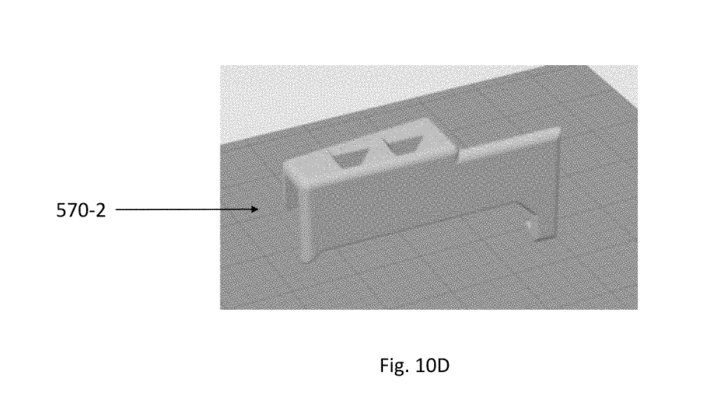

FIGS. 10A and 10C illustrate cameras 550-1, 550-2 and video storage units 560-1, 560-2 mounted to head wear 121, 122, respectively, according to the embodiments of the present invention. Mounts 570-1, 570-2, as best seen in FIGS. 10B and 10D, are configured to attach the video storage units 560-1, 560-2 to the head wear 121, 122, respectively.

While the systems detailed herein may be used with any number of head wear, the following paragraphs detail the use of certain systems with specific head wear brands.

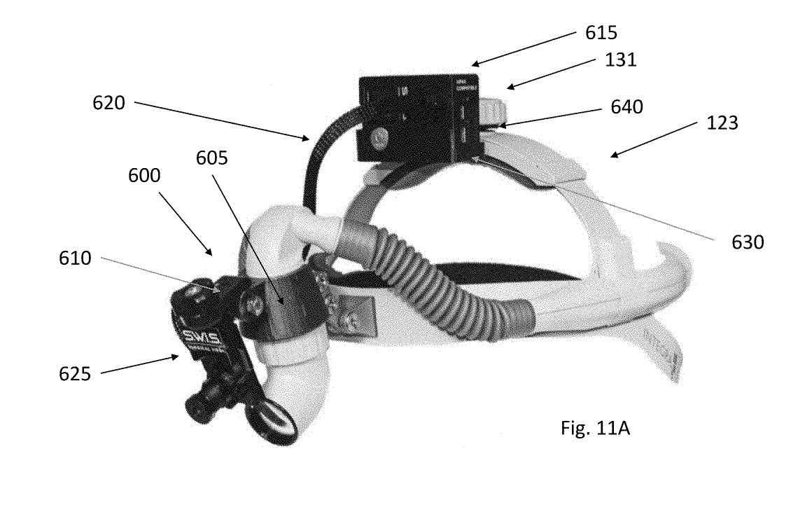

FIG. 11A illustrates a custom mount 600 on an Integra-branded head wear 123 according to the embodiments of the present invention. The mount 600 includes a collar 605 and linkage 610. A video storage unit 615 is attached to camera 625 via cable 620. Mount 630 secures the video storage unit 615 to the head wear 123. FIG. 11B shows the mount 630 without the video storage unit 615 in place. As best seen in FIG. 11B, the video storage unit mount 630 comprises a platform 635 and connection ring 640 and aperture 645 for allowing said video storage unit mount 630 to be screwed to the head wear 123 using head wear hardware 131.

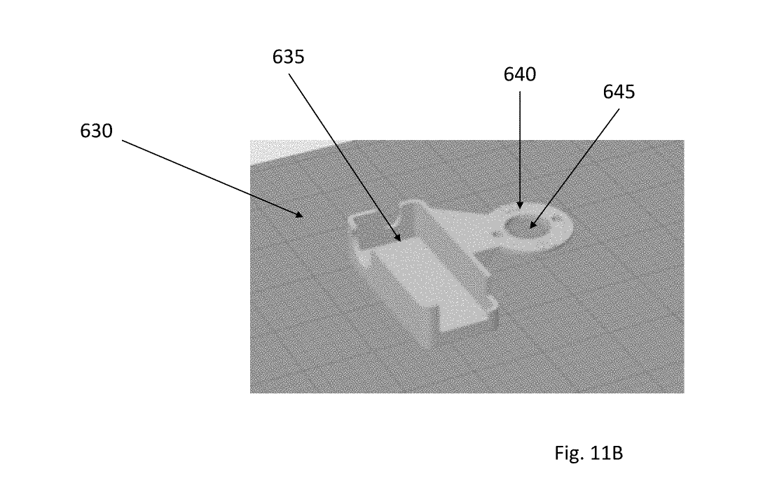

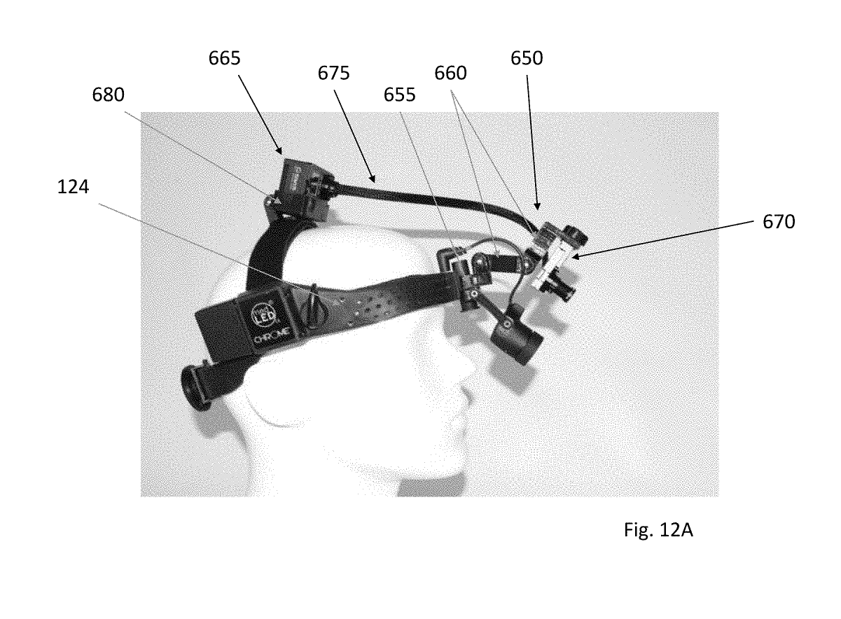

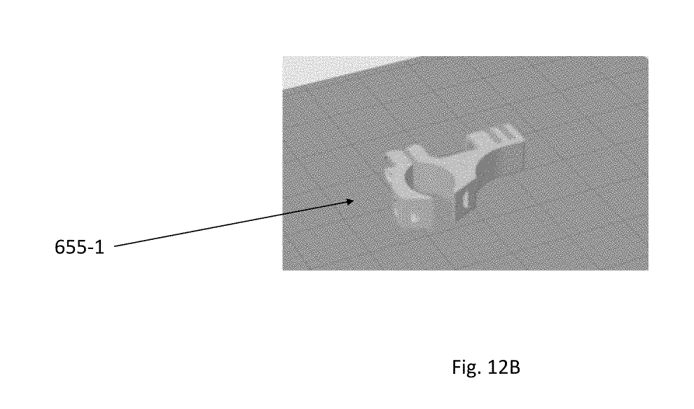

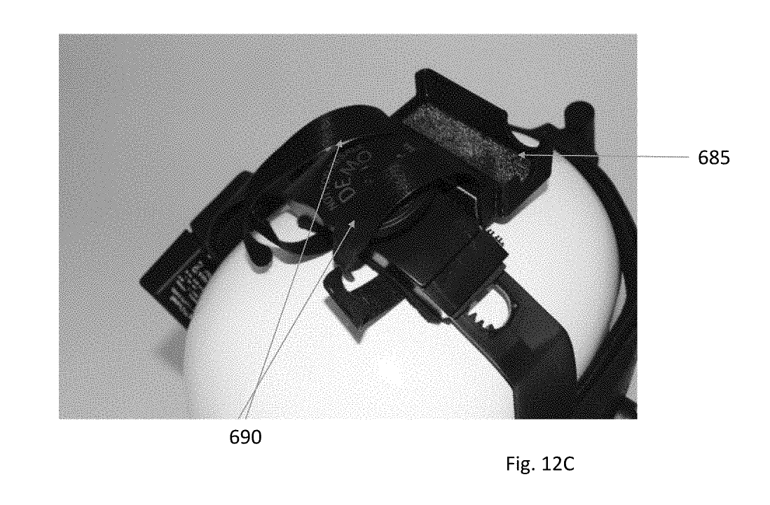

FIG. 12A illustrates a custom mount 650 on a MedLED-branded head wear 124 according to the embodiments of the present invention. The mount 650 includes a collar 655 and linkage 660. A video storage unit 665 is attached to camera 670 via cable 675. FIG. 12B shows a collar 655-1 of the type that may attach the mount 650 to the head wear 124. Mount 680 secures the video storage unit 665 to the head wear 124. FIGS. 12C and 12D show the mount 680 without the video storage unit 615 in place. The video storage unit mount 680 comprises a platform 685 and connection straps 690 for allowing said video storage unit mount 680 to be attached to the head wear 124. In one embodiment, the straps 690 are hook and loop fasteners which can attach to a section of hook and loop fastener material 692 on a block member 695 through which the straps 690 pass.

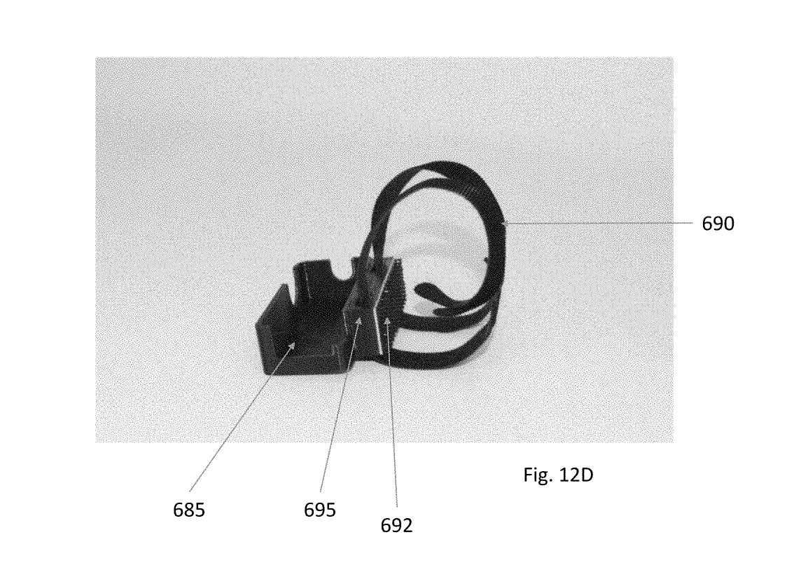

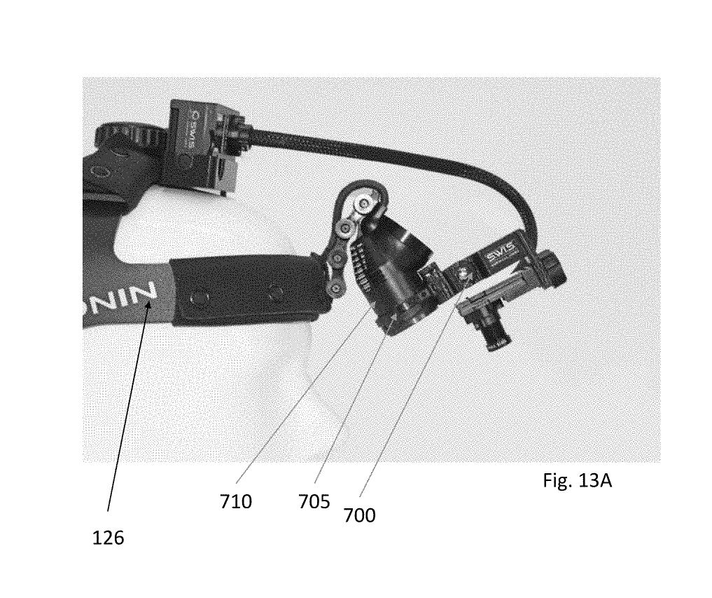

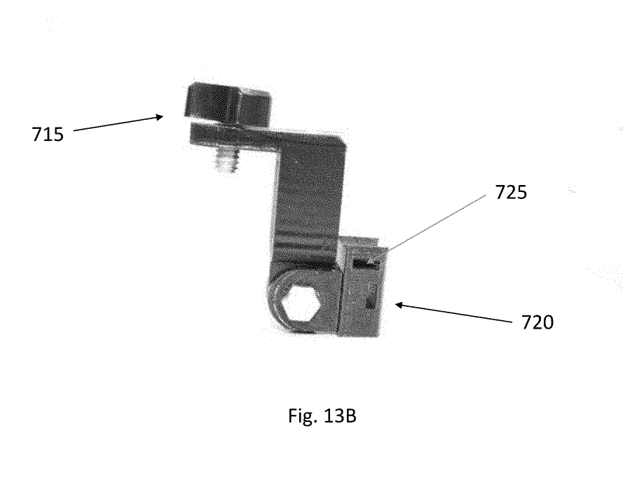

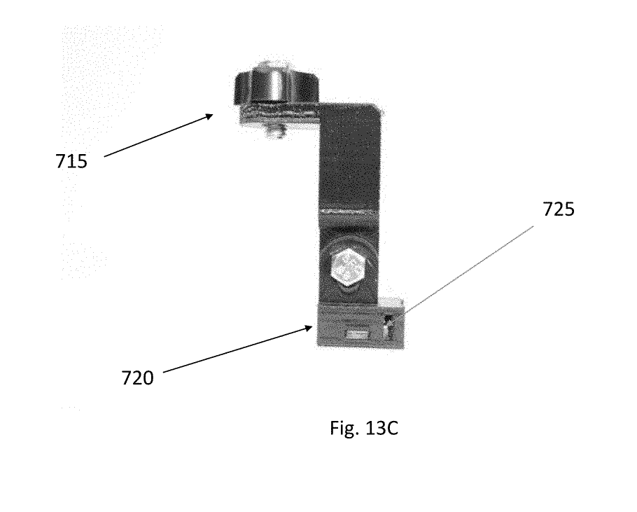

FIG. 13A illustrates a custom mount 700 on a Ronin-branded head wear 126 according to the embodiments of the present invention. The mount 700 is secured via a zip-tie 705 or other fastener to a light 710 associated with the head wear 126. FIGS. 13B and 13C illustrate the mount 700 from FIG. 13A according to the embodiments of the present invention. The mount 700 includes a camera connector 715 on one end and a light connector 720 on an opposite end. The slot 725 in the light connector 720 receives the zip-tie 705. The mount 700 may be used with other head wear types as well.

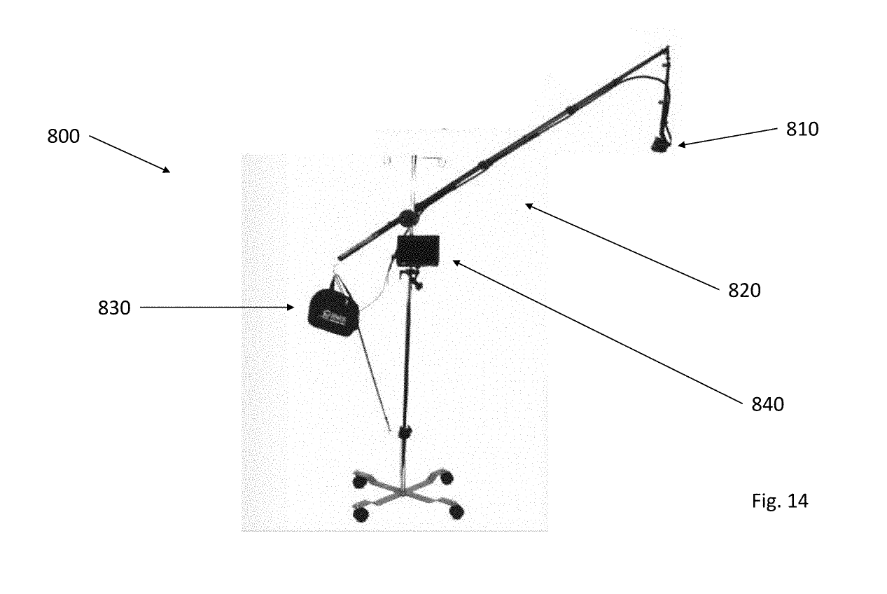

FIG. 14 illustrates a surgery camera video boom system 800 according to the embodiments of the present invention. The video boom system 800 comprises a video camera (e.g., GoPro®) 810, video boom and stabilizing system 820, battery 830 and live view system 840.

The systems detailed herein capture video which may then be disseminated using various other compatible hardware and software as described in applicant's co-pending patent application Ser. No. 15/422,311 filed Feb. 1, 2017.

Although the invention has been described in detail with reference to several embodiments, additional variations and modifications exist within the scope and spirit of the invention as described and defined in the following claims.

I claim:

1. A system comprising:
a video camera;
head wear configured to assist with surgical procedures;
a camera mount comprising a clip or adjustable clamp, and linkage, said clip or adjustable clamp configured to attach to said head wear; and
wherein said linkage permits said video camera to be adjusted when retained by said camera mount.

2. The system of claim 1 wherein said camera mount includes a camera retention member in the form of a camera frame connected to said linkage.

3. The system of claim 2 wherein said camera retention member includes cut-outs.

4. The system of claim 1 further comprising a video storage unit and video storage unit mount, said video storage mount configured to attach to said head wear.

5. The system of claim 4 wherein said video storage unit mount comprises a platform and connection ring and aperture for allowing said video storage unit mount to be screwed to said head wear using head wear hardware.

6. The system of claim 1 further comprising a remote monitor configured to receive and display live images being captured by said portable video camera.

7. The system of claim 1 further comprising a display viewable by a wearer of said head wear, said display showing live content being captured by said portable video camera.

8. The system of claim 1 further comprising a video boom system including a video camera, video boom and stabilizing system, battery and live view system.

9. A system comprising:
a pair of video cameras;
head wear configured to assist with surgical procedures;
a dual camera mount comprising a clip or adjustable clamp, and linkage, said clip or adjustable clamp configured to attach to said head wear; and
wherein said linkage permits a pair of video camera to be adjusted when retained by said dual camera mount.

10. The system of claim 9 wherein said camera mount includes a camera retention member in the form of a camera frame connected to said linkage.

11. The system of claim 10 wherein said camera retention member includes cut-outs.

12. The system of claim 9 further comprising a video storage unit and video storage unit mount, said video storage mount configured to attach to said head wear.

13. The system of claim 12 wherein said video storage unit mount comprises a platform and connection ring and aperture for allowing said video storage unit mount to be screwed to said head wear using head wear hardware.

14. The system of claim 9 further comprising a remote monitor configured to receive and display live images being captured by said portable video camera.

15. The system of claim 9 further comprising a display viewable by a wearer of said head wear, said display showing live content being captured by said portable video camera.

16. The system of claim 9 further comprising a video boom system including a video camera, video boom and stabilizing system, battery and live view system.

17. A system comprising:
head wear configured to assist with surgical procedures;
one or more video cameras;
a camera mount comprising a clip or adjustable clamp, and linkage, said clip or adjustable clamp configured to attach to said head wear wherein said linkage permits said one or more video cameras to be adjusted when retained by said camera mount;
one or more video storage units, said one or more video storage units in connection with said one or more video cameras to store captured video data; and
one or more video storage unit mounts configured to attach said one or more video storage units to said head wear proximate said one or more video cameras.

18. The system of claim 17 wherein said camera mount includes a camera retention member in the form of a camera frame connected to said linkage.

19. The system of claim 18 wherein said camera retention member includes cut-outs.

20. The system of claim 18 wherein said one or more video storage unit mounts comprise a platform and connection ring and aperture for allowing said one or more video storage unit mounts to be screwed to said head wear using head wear hardware
